(19) United States
(12) Patent Application Publication
(10) Pub. No.: US 2008/0306791 A1
(43) Pub. Date: Dec. 11, 2008

(54) Method and system for utilizing drive-time calculation

(76) Inventor: Robert Rubertone, Glen Head, NY (US)

Correspondence Address: Thomas A. O'Rourke;Bodner & O'Rourke, 425 Broadhollow Road, Melville, NY, 11747, US

(21) Appl. No.: 12/154,969

(22) Filed: May 28, 2008

Related U.S. Application Data
(60) Provisional application No. 60/932,105, filed on May 29, 2007.

(51) Int. Cl. G06Q 10/00

(52) U.S. Cl. 705/7

(57) ABSTRACT

Described is a method and system for tracking leads and setting appointments. In the method and system an inquiry is received from a prospect. The zip code of a location for the prospect is entered into a database on a computer system. This database contains the estimated drive time between every pair of zip codes in a preselected territory. All prior recorded appointments in the database that are scheduled for future dates and times are identified and the estimated drive time from each of said appointments to the zip code location of the prospect is determined. A table of the estimated drive times from the prospect to the prior recorded appointments is created so that an appointment time and date can be selected with the shortest drive time.

The present application claims priority on U.S. Provisional Patent Application Ser. No. 60/932,105, filed on May 29, 2007, the disclosures of which are incorporated herein by reference.

### FIELD OF THE INVENTION

The present invention is directed to a system and method for tracking leads and planning appointments to conserve time and energy primarily by home improvement and home service contractors.

### BACKGROUND OF THE INVENTION

Many home improvement companies and contractors receive inquiries from potential customers when they have to travel to a site and meet with customers to ultimately provide an estimate for the work. Many larger contractors and home improvement companies have a dedicated staff who travel to provide the estimates to potential customers. Smaller contractors and home improvement companies frequently do not have the luxury of staff and have to make these appointments among their other responsibilities. Many of these smaller contractors will visit job sites throughout the day, pick up supplies and meet with potential customers. As the price of fuel has increased, there has also been a need for small contractors and home improvement companies to plan both their time and their travel so that their travel time and fuel usage is minimized.

While GPS systems are useful for providing directions for the shortest route from Point A to Point B, these systems do not prepare a route that takes into consideration a number of destinations and routes out an itinerary that picks the shortest distances for the series of locations.

Further complicating the process is that the appointments can vary over the course of the day. Thus, both time and distance can factor into the calculation. The GPS system also does not factor in the scheduled times of previously set appointments in calculating a route.

Until now there has not been a means for a contractor or home improvement company to identify routes based on time and location to reduce travel time and fuel usage.

### OBJECTS OF THE INVENTION

It is an object of the invention to provide a system and method to set a route that considers distances from a starting point and each of the stops on a route.

It is also an object of the invention to provide a route setting system that sets a route based on distance as well as time of the appointments.

It is a still further object of the invention to provide a system and method that takes the distance of an appointment as well as the time and location of an appointment combined with the time and distance of other appointments, their times and locations.

### SUMMARY OF THE INVENTION

The present invention is directed to a web-based software application intended to be used by home improvement and home services contractors for use in tracking leads and setting appointments for in-home consultations and estimates.

The present invention utilizes a web browser such as Internet Explorer to access pages which are run on a web-server either via the internet or on a server located at the user's facilities. It is a client-server application which utilizes a back-end database to store data.

In the home improvement/home services industry, leads are received from many sources. This would include traditional marketing methods such as newspaper and radio advertisement as well as more recent internet based marketing methods such as web sites, banner ads and email blast campaigns.

When a homeowner responds to any of the marketing advertisements, a “lead” is created in the system to track the contact with the homeowner. In still other cases, the initial contact with the homeowner will be through a two-way telephone conversation with the homeowner. In other cases, the initial inquiry is a one-way communication, such as a voicemail or email message from the homeowner expressing an interest in the products or services the company has to offer. In either event, the next step in the sales process is to schedule an appointment with the homeowner, usually at the homeowner's residence, in order to provide a consultation or estimate of the cost of services desired.

Typically, a home improvement/home services company will employ a staff of salespeople whose primary job it is to make these in-home visits. During the course of a typical work day, such a salesperson might make 3 or more in-home visits, making it most likely that the salesperson would travel directly from one appointment to the next. As such, careful consideration must be made in scheduling appointments so that adequate travel time is allowed in order to assure that the salesperson will arrive at the next appointment on a timely basis. Furthermore, it is in the best interest of the home improvement/home services company to schedule appointments efficiently so as to minimize travel time between appointments thus allowing more appointment to be handled by a single salesperson. In addition, since many salespeople are paid primarily on a commission-basis, minimizing travel time increases the satisfaction of the salesperson, thus reducing employee turnover.

### BRIEF DESCRIPTION OF THE DRAWINGS

FIG. 1 is a flow chart showing key data base tables and relationships.

FIG. 2 is a flow chart of the logic of the method of the present invention.

FIG. 3 is a representative screen showing a series of appointments.

FIG. 4 is a representative screen showing sample appointments for individual salespersons.

### DETAILED DESCRIPTION OF THE INVENTION

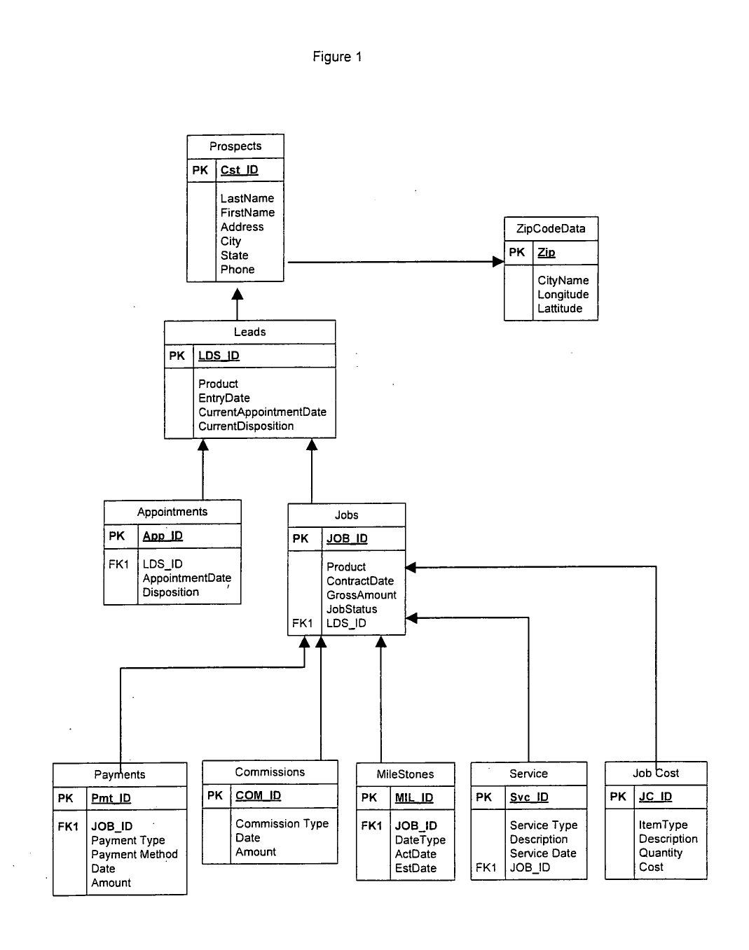

The present invention utilizes a unique approach in scheduling appointments. As seen in FIG. 1, the present invention is a system and method which specializes in managing business in the home improvement and home services industries. It utilizes preferably a relational database to store data, and, for example, Microsoft's NET platform for its user interface, which is 100% web based.

There are a number of tables that can be included in the database. The preferred tables could include but are not limited to tables for:

Prospect Information

Leads

Zip Code Information

Appointment History

Jobs (Sales Contracts)

Payments

Commissions

Job Milestones

Service and Repair History

Job Costing

Within the parent-to-child relationship between these tables, the Prospect table is preferably at the highest level. It could contain a single record for each prospect for which the end user would like to maintain. The prospect table contains primarily name and address information regarding for the homeowners, and their primary telephone number. Besides the tables listed above, there are many additional tables which allow the end user to enter additional contact names and telephone numbers, demographics, telephone call history, and other details concerning the home owner and their property.

The Leads table is a child to Prospects. Any given prospect can have more than one lead. This would happen in cases where a lead was received from a prospect that had a lead some time previously. The system will track multiple leads from prospects over time, so that historical reports can be run which quantify sales results based upon the lead source and date range in which leads were received.

The system can also maintains a Zip Code table which lists all of the valid zip codes in the U.S. This table is useful in validating data entry and determining simplistic distance estimates based upon straight-line (as the crow flies) calculations.

The Appointments table can contain a history of each appointment that was booked with a given prospect. As prospects cancel and reschedule appointments, the system will create a new appointment record. Therefore, any given lead can have multiple appointments, and the Appointment table is a child of the Leads table.

The Jobs table can contain a single record for each sale that is made. Sales reps are sent out on the appointments that are booked, and a percentage of these will result as sales. The Jobs table contains all of the basic information concerning the contract, including the contract date, amount, product and status. The Jobs table is a child of the Leads table. A given lead can result in multiple contracts. In this case, there will be multiple job records for any given lead, and the Jobs table is considered a child of the Leads table.

There can be several key tables which are children of the Jobs table. These tables contain various details about the job. Each of these tables can contain multiple rows of data. They include:

Payments—One record for each installment paid by the customer

Commissions—Details of commission payments to sales reps for the given job

Milestones—Estimated and Actual dates of key events in the life cycle of a job

Service—History of all service calls for repairs and maintenance for jobs

Job Cost—Material and Labor used to complete a job

### Identification of Nearby Appointments

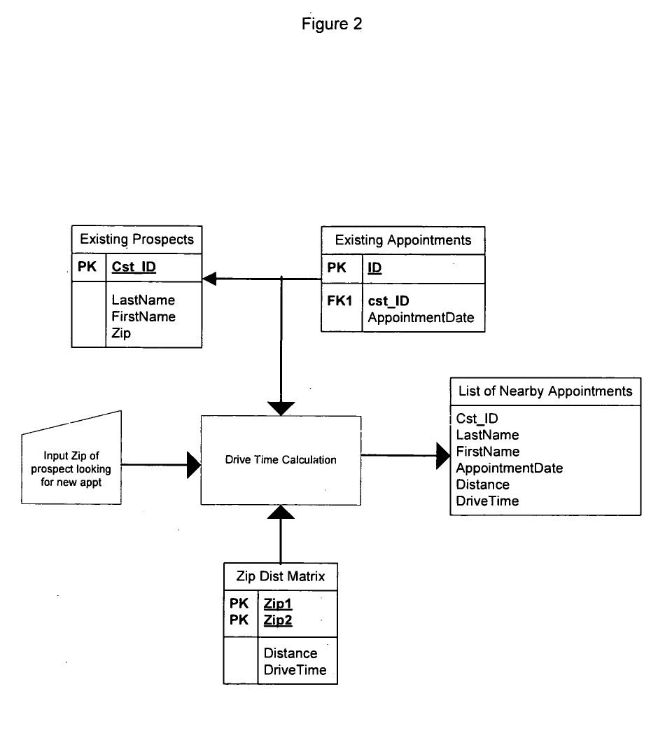

FIG. 2 shows the Drive Time Calculation Identification of Nearby Appointments. One of the preferred features in the present system is the ability to quickly identify the best time to set an appointment with a homeowner. The “best time” will take into consideration the estimated driving time and mileage from the previous and/or next appointments in the day that are eventually given to a sales person.

In order to allow the appointment setter to be able to quickly identify the best time while on the phone with a potential customer, the system uses a unique methodology. The user will enter the zip code of the person who desires an appointment. The system will then select all future appointments on the schedule and join this to the Prospect record in order to create a temporary recordset with the appointment information and prospect information. Included in the prospect information is the prospect zip code, which is a key to the process.

The system will then perform a lookup in the “Zip Distance Matrix” table for all the records in the temporary recordset, and update the recordset for the estimated drive time and estimated driving mileage from the prospect on the phone to all of the appointments on the schedule. The results are listed on the screen which the appointment setter can review and quickly identify the best appointment time available.

The lookup in the “Zip Distance Matrix” table is done by searching on a composite key which is the combination of the new prospects zip code and the zip code of each prospect with a future appointment date. The Zip Distance Matrix table contains a single record for every permutation of U.S. zip code in the U.S. within 300 miles of each other and are located in the coverage area for a given client using the system.

It is not necessary to include every permutation of every zip code, as typical clients operate within a limited geographical region. This region is identified as part of the implementation of the system, and the Zip Distance Matrix is loaded with the necessary subset of records in order to provide useful information for a given installation.

During its initial implementation, a table is created in the database which contains the permutation of estimated drive time between every pair of zip codes in the territory in which the given home improvement/home services company currently operates. This table is referred to as the “drive-time matrix”. For example, if a given company covers a territory which encompasses 1000 zip codes, the drive-time matrix will be populated with 500,000 records (1,000×1,000/2). Each record will contain a “from” and “to” zip code along with the estimated mileage and estimated drive time between these two zip codes. It should be noted that the permutation of zip codes is divided by 2 because it is assumed that the drive-time between zip code A and zip code B is approximately the same as between zip code B and zip code A.

The table below represents 5 records found in a typical drive-time matrix table of the present invention. In this case, distance is expressed in miles, and driving time is expressed in days. Thus, the estimated driving time from zip code 23004 to 23022 would be 24.1 minutes (0.01673611×24×60).

| Zip1 | Zip2 | Distance | DrivingTime |
|---|---|---|---|
| 23004 | 23022 | 15.77661477 | 0.01673611 |
| 23004 | 23040 | 19.6788259 | 0.02737269 |
| 23004 | 23055 | 18.92696675 | 0.01943287 |
| 23004 | 23901 | 33.23714549 | 0.03538194 |
| 23004 | 23915 | 89.62720326 | 0.08479167 |

The drive-time matrix is populated during the initial implementation of the program by utilizing third-party mapping software as a source for the distance and driving time between any two zip codes. An interface can be implemented with the third-party mapping software to loop through the permutation of zip codes required to calculate each accordingly.

Once the drive-time matrix is populated in, for example, an SQL table, it can be utilized for various purposes. First and foremost is utilizing it to assist in the selection of an appropriate appointment date and time while the homeowner is on the telephone. In this case, the homeowner will provide his zip code and the present invention will run a SQL query that will return all of the other appointments that the company already has scheduled along with the estimated drive-time between each of those appointments and the residence of the customer with whom they are speaking.

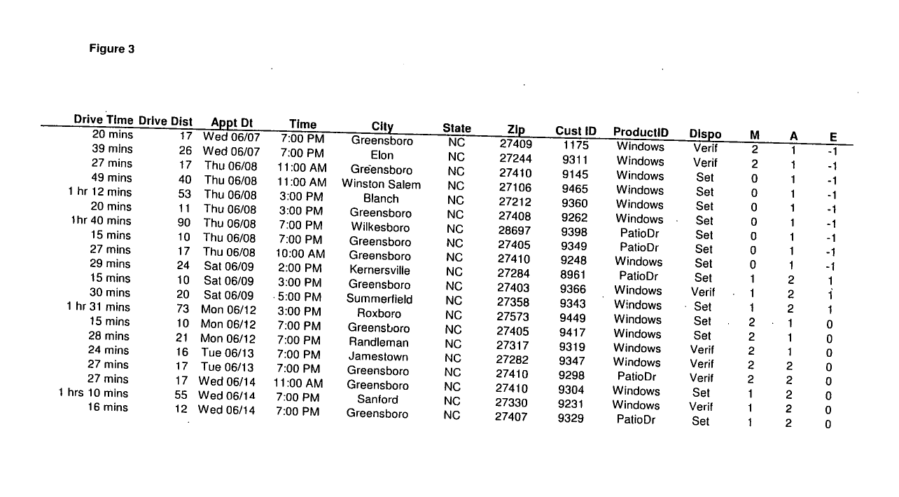

The screen-shot of FIG. 3 is a representation of what the software would typically produce for a case where a customer, in this case residing in zip code 27406, were to call the company on June 7^{th} requesting an appointment. Each row in the table represents other appointments which have already been booked. The first two columns represent the estimated drive time and distance between the each of the previously booked appointments and that of the new customer. The 3^{rd} through 8^{th} columns represent various details of each of the previously booked appointments. The last three columns represent availability of salespeople for different “shifts” of the day, in this case “M”, “A” and “E” for “Morning”, “Afternoon” and “Evening”, respectively.

By viewing the table of FIG. 3, the user of the system can quickly determine that a salesperson would be within 20 minutes of the new customer at 7 PM on June 7^{th}. Therefore, an earlier appointment, perhaps mid-afternoon would be desirable.

Optional criteria can be utilized to modify the timeframe and initial radius utilized to limit the number of rows to be returned by the query. Therefore in the case above, if no mutually agreeable appointment times could be found for the 8 days listed, the user could expand the search criteria to either include a wider radius or appointments further into the future.

In addition to assisting in the initial selection of appointment times with new customers, the drive time matrix is useful in visualizing the actual routing of appointments which salespeople are to make.

In a typical home improvement/home services company, appointments are booked up to two weeks in advance. However, actual assignment of those appointments to individual salespeople might not be made until as late as the day of the appointment by an “expediter”. This allows the expediter to assign each appointment to a salesperson most qualified to handle the specific details that each unique appointment might include. As such, it is important for the expediter to determine the expected drive time which will result from such assignments. The software has an “assignment” page which allows this to be done efficiently.

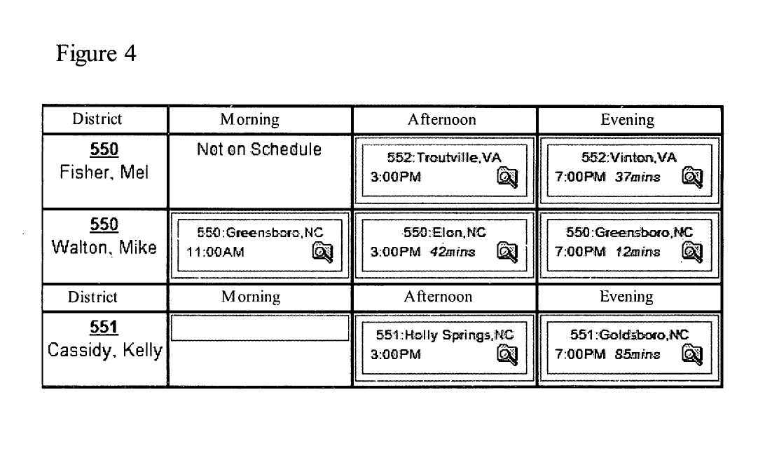

The screen-shot of FIG. 4 represents a portion of a typical schedule which an expediter would be required to manage. Each row represents a sales person whose name is listed in the first column. The remaining columns represent portions of the day in which appointments are to be made. In the event that a given salesperson is unavailable to work in any portion of a day, the system will gray-out the box and list it as “Not on Schedule” for the given sales person. In cases where appointments have been assigned by the expediter, the city, state and time will be listed along with the estimated driving time from the previous appointment.

So for example, the software has determined that by assigning the 7 PM Vinton, Va. appointment to Fisher, a driving time of 37 minutes will result since the previous appointment was in Troutville, Va. This was calculated by performing a lookup on the drive-time matrix for the zip codes for each of these two appointments.

The expediter has the ability to drag-and-drop each of the appointments into the rows for any of the salespeople listed, and as changes are made, the system will recalculate the driving time accordingly.

In one embodiment, for each zip code, a predefined point is selected to which drive time will be calculated to the permutation of all other zip codes in the general territory in which a company operates. This predefined point, often near the center of the zip code territory we will refer to as the “center point” even though it need not be the actual center point of the zip code. It is from and to these center points that each drive time in the matrix is calculated and pre-loaded. Since, in general, most of the zip codes in the United States are less than a few miles in radius, and since, in general, such zip codes are often defined using natural boundaries such as rivers, lakes and canyons, the error in calculating the drive time between actually stops on the route versus the predefined center points of the zip codes in which they reside is negligible in nearly all but the most rural regions of the United States.

By utilizing a pre-calculated permutation of all zip code “center points”, it allows the user of the software to view the drive time estimated between appointments which have already been scheduled and that of a potential customer on the telephone with whom an appointment is about to be scheduled. Normally, calculating the exact drive time without such use as a permutation of zip codes would take far too long, as each would take several seconds and there could potentially be dozens or even hundreds of existing appointments from which to calculate. A delay of more than a few seconds would cause unnecessary frustration on the part of the potential customer, therefore rendering such a method unusable. Instead, this method will return results in a few seconds, within an acceptable range or error, thus achieving the goal of estimating driving distances without a significant time lag.

1. a method for tracking leads and setting appointments comprising:
a) receiving an inquiry from a prospect;
b) entering the zip code of a location for the prospect into a database on a computer system, said database containing the estimated drive time between every pair of zip codes in a preselected territory;
c) identifying all prior recorded appointments in the database that are scheduled for future dates and times and determining the estimated drive time from each of said appointments to the zip code location of said prospect;
d) creating a table of the estimated drive times from the prospect to said prior recorded appointments so that an appointment time and date can be selected with the shortest drive time.

2. The method according to claim 1 wherein said data base has a zip code distance matrix with the estimated drive time and estimated distance to and from each zip code in the matrix.

3. The method according to claim 2 wherein the future appointments are joined with the zip code of said prospect to create a temporary recordset with appointment information and prospect information.

4. The method according to claim 3 wherein the best time for the appointment based on calculating the driving time and mileage said prior recorded appointments.

5. The method according to claim 4 wherein a lead is created to track prospect data.
